(19) United States
(12) Patent Application Publication
(10) Pub. No.: US 2024/0248704 A1
(43) Pub. Date: Jul. 25, 2024

(54) SOFTWARE DISTRIBUTION PACKAGE PARSER

(71) Applicant: Ivanti, Inc., South Jordan, UT (US)

(72) Inventors: Garland Michael Krueger Port, Centerville, MN (US); Ethan Larson, St. Louis Park, MN (US)

(73) Assignee: Ivanti, Inc., South Jordan, UT (US)

(21) Appl. No.: 18/423,123

(22) Filed: Jan. 25, 2024

Related U.S. Application Data
(60) Provisional application No. 63/481,475, filed on Jan. 25, 2023.

(51) Int. Cl. G06F 8/65; G06F 8/41

(52) U.S. Cl. CPC G06F 8/65; G06F 8/427

(57) ABSTRACT

A method of unsupported product update data conversion includes receiving an initial software distribution package including rules to detect a product update status and to install a product update on an endpoint. The product update is not supported by a third-party update network. The method includes identifying elements of a rule. The method includes parsing the elements of the rule, which includes adding parent components representative of the elements to an expression tree and detecting functions for the elements. The functions are configured to implement the elements in the third-party update network. The method includes aggregating the functions for the parsed elements into a script file. The method includes converting the expression tree into a final command to perform the script file. The method includes generating a compatible update package based on the final command and distributing it to the third-party update network to deploy the product update.

### CROSS-REFERENCE TO RELATED APPLICATION

This application claims the benefit of and priority to U.S. Provisional Application No. 63/481,475, filed Jan. 25, 2023, which is incorporated herein by reference in its entirety.

### FIELD

The embodiments described in this disclosure are related to automated endpoint product management, and in particular to a software distribution package (SDP) parser for implementation of product updates in third-party update networks.

### BACKGROUND

In enterprise and other managed networks, an endpoint refers to a computing device that is integrated into the network. In some managed networks, the endpoints are in communication with a management device, which is also included in the managed network. The management device may include a server device, for instance, which has visibility to operating parameters and state parameters of the endpoints. Based on information communicated between the management device and the endpoints, the management device may detect issues at the endpoints, deploy solutions to the endpoints, update software on the endpoints, troubleshoot issues at the endpoints, provision roles and security controls to the endpoints, etc. In some managed networks, management of the endpoints may be outsourced. In these managed networks, there is not a specific management device included in the managed network. Instead, a cloud-based service may be implemented to perform some or all of the operations related to management of the endpoints.

One management operation of the managed networks is coordination and distribution of product updates. Sometimes this operation is referred to as patch or product update management. The updates or patches include code changes to products on the managed endpoints or some subset thereof. The products that are updated include software applications, software tools, operating systems, and the like. Distribution of the updates is important to ensure the products are properly functioning and to ensure security vulnerabilities are addressed.

In some circumstances, a vendor publicizes the updates that are relevant to its products. Publication of the updates is an ongoing process. For instance, MICROSOFT® has routinely released software patches on “Patch Tuesday” which occurs on the second and sometimes the fourth Tuesday of each month. In addition, software patches might be released and published responsive to detection of a specific vulnerability. Following publication of the software patches, administrators of the managed networks may access and distribute the product updates.

Some managed endpoints include multiple products. Patch management of some portion of these products may be performed by a third-party update network. The third-party update might include a server or a cloud-based software service provider that hosts product updates for this portion of the products and enables the managed endpoints to access these product updates. Additionally, the third-party update network may include automated detection features, which enable an update status of the products to be ascertained.

However, the products supported by third-party update networks may be limited. As a result, there may exist on the managed endpoints another portion of products that cannot be directly managed by the third-party update network. Accordingly, another patch management systems may act as an intermediary to enable management of unsupported products on the managed endpoints. The patch management entity may interact with the third-party update network to enable deployment of product updates for unsupported products via the third-party update network.

In general, conventional patch management systems receive software update data and manually derive instructions that can be implemented in the third-party update network. Manual derivation of these instructions is error prone and requires considerable resources. Some conventional patch management systems may alternatively provide one or more instruction templates to conform the update data to usable instructions. The instruction templates may be used to derive instructions such as detection instructions and deployment instructions for a particular vendor (e.g., all products by a vendor include the same instructions). The instruction templates provide the same general instructions with some variations for product or version parameters. Other patch management systems provide a single set of instructions for multiple vendors, and yet other patch management systems simply eliminate detection instructions, which result in automated deployment of product updates without assessing the update status or necessity and applicability of the product update. Accordingly, use of these conventional patch management systems may result in product updates that are unnecessarily loaded to managed endpoints or incorrectly loaded to managed endpoints.

Accordingly, there is a need for a patch management system to receive SDPs for unsupported products and generate compatible update packages that may be implemented in third-party update networks. The subject matter claimed herein is not limited to embodiments that solve any disadvantages or that operate only in environments such as those described. Rather, this background is only provided to illustrate one example technology area where some embodiments described herein may be practiced.

### SUMMARY

According to an aspect of the invention, an embodiment includes a method of conversion of an unsupported product update package for implementation on a third-party update network. The method may include receiving an initial software distribution package (initial SDP). The initial SDP may include one or more rules executed to detect a product update status associated with a product at an endpoint of a managed network and/or to install a product update associated with the product on the endpoint. The product may not be supported by the third-party update network implemented to manage product updates on the endpoint. The initial SDP may include an extensible markup language (XML) file and may be included as update catalog entry for the product in an update catalog that aggregates multiple product update packages. The method may include identifying one or more elements of a first rule of the one or more rules of the initial SDP. The method may include parsing the one or more elements of the first rule. The parsing may include adding parent components that are representative of the one or more elements to an expression tree associated with the initial SDP and detecting one or more functions for the one or more elements. The one or more functions are configured to implement or control implementation of at least a portion of one element of the one or more elements in the third-party update network. The one or more functions may include shell functions that access management functions of an operating system of the third-party update network such as PowerShell® cmdlet in Microsoft Intune®. The parsing may further include determining whether a first element of the elements include a compound rule (e.g., including an “AND” operator, an “OR” operator, or an “NOT” operator). Responsive to the first element including the compound rule, a first child element and a second child element of the first element may be identified. Child components representative of the first and second child elements may be added to the expression tree. Also, one or more additional functions for the first child element and the second child element may be detected. The method may include aggregating the functions for the parsed elements into a script file. The method may include converting the expression tree into a final command to perform the script file. The method may include generating a compatible update package based on the final command. The method may include distributing the compatible update package to the third-party update network to deploy the product update to the endpoint.

The method may also include receiving update data related to a second product update for a second product. The update data may not include a detection rule executed to detect a second product update status associated with the second product at the endpoint. The second product may not be supported by the third-party update network. Also, the update data related to a second product update may be formatted according to a non-XML programming language. The method may include identifying an assessment element related to the update data. The assessment element may be configured to implement or control implementation of an operation to detect the second product update status at the endpoint by the third-party update network. The method may include parsing the assessment element to identify assessment functions that correlate to the assessment element. The method may include generating an assessment script for the second product update, the assessment script including the assessment functions. The method may include aggregating the assessment functions into an assessment script file. The method may include generating a compatible assessment product update package based on the assessment script file. The method may include distributing the compatible assessment product update package to the third-party update network for deployment to the endpoint. The compatible assessment product update package may further include an instruction to install the second product update at the endpoint responsive to the second product update status indicating an unpatched state exists at the endpoint relative to the second product.

A further aspect of an embodiment may include non-transitory computer-readable medium having encoded therein programming code executable by one or more processors to perform or control performance of one or more of the operations of the methods of conversion of an unsupported product update package described above.

An additional aspect of an embodiment may include compute device comprising one or more processors and a non-transitory computer-readable medium having encoded therein programming code executable by one or more processors to perform or control performance of one or more of the operations of the methods of conversion of an unsupported product update package described above.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 depicts a block diagram of an example operating environment in which some embodiments described in the present disclosure may be implemented;

FIG. 2 depicts a block diagram of an example automated software management process (management process) that may be implemented in the operating environment of FIG. 1;

FIGS. 3A-3E provide example input and output from the management process of FIG. 2;

FIG. 4 depicts an application programming interface (API) that may be implemented to generate assessment scripts using the management process of FIG. 2;

FIG. 5 is a flow chart of an example method of conversion of an unsupported product update package;

FIG. 6 is a flow chart of an example method of conversion of unsupported update data;

FIG. 7 is a flow chart of an example method of parsing an element; and

FIG. 8 illustrates an example computer system configured for conversion of an unsupported product update data for deployment via a third-party update network,

all according to at least one embodiment described in the present disclosure.

### DESCRIPTION OF SOME EXAMPLE EMBODIMENTS

The embodiments described in this disclosure are related to automated endpoint product management, and in particular to conversion of software distribution package (SDP) using an SDP parser for implementation of product updates in third-party update networks.

The embodiments of the present disclosure address technical problems that exist in conventional patch management systems. For instance, some conventional patch management systems are built around a third-party update network. The third-party update network is configured to distribute product updates to endpoints and other managed devices. However, the third-party update network may limit distribution and management of some product updates, which are referred to in this disclosure as unsupported products. Accordingly, the third-party update network fails to integrate product updates for the unsupported products, which decreases management of the unsupported products.

To manage endpoints having unsupported products, conventional patch management systems provide instructions that enable the third-party update network to implement the product updates. However, these instructions are not specifically derived from SDPs related to the unsupported products. Instead, these instructions are manually derived to apply to multiple unsupported products, multiple unsupported vendors, or simply push product updates without endpoint-specific assessment of the unsupported products.

Some embodiments of the present disclosure address these technical problems. For instance, these and other embodiments include an SDP parser that receives an initial SDP for an unsupported product. The SDP parser derives a compatible update package that may be implemented by the third-party update network. The SDP parser tracks each path of the initial SDP and detects functions that perform corresponding operations in the third-party update network. The compatible update package includes a script file and a final command that is distributed to the third-party update network, which enables product update distribution via systems of the third-party update network.

Additionally, the SDP parser in some embodiments dynamically derives the compatible update package. Accordingly, complex initial SDP having multiple compound operators and multiple execution paths may be converted to compatible update packages. This provides an advantage over static libraries and static instructions that may be implemented in conventional patch management systems. Specifically, static libraries are unable to include sufficient numbers of functions to address complex SDPs. Some embodiments are directed to extensions of a third-party update network such as Microsoft® Intune®. In these and other embodiments, the compatible update package may include PowerShell® commands in a script file.

These and other embodiments are described with reference to the appended Figures in which like item number indicates like function and structure unless described otherwise. The configurations of the present systems and methods, as generally described and illustrated in the Figures herein, may be arranged and designed in different configurations. Thus, the following detailed description of the Figures, is not intended to limit the scope of the systems and methods, as claimed, but is merely representative of example configurations of the systems and methods.

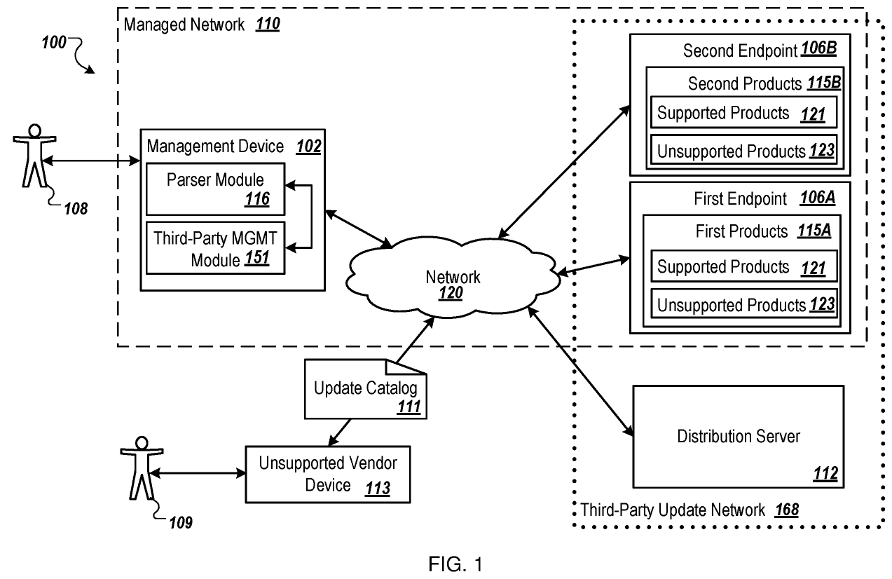

FIG. 1 is a block diagram of an example operating environment 100 in which some embodiments of the present invention may be implemented. The operating environment 100 may be configured for implementation of product update management of endpoints 106A and 106B (generally, endpoint 106 or endpoints 106). The endpoints 106 may be included in a managed network 110 as well as a third-party update network 168. The third-party update network 168 may be primarily responsible for product update management of the endpoints 106. The managed network 110 may be configured for additional functions that supplement one or more of the processes performed in the third-party update network 168.

The product update management implemented in the operating environment 100 may enable product updates such as software patches and code changes to be accessed, consumed, and distributed to the endpoints 106 indirectly via the third-party update network 168. For example, the management device 102 may include a parser module 116. The parser module 116 is configured to automatically generate compatible update packages for use with the third-party update network 168. The parser module 116 receives an initial SDP and/or update data for unsupported products 123, parses multiple or all paths of the initial SDP or update data, and detects functions that perform detection and installation operations in the third-party update network 168. The parser module generates a compatible update package based on the functions. The compatible update package includes a script file including an aggregation of the functions.

These embodiments of the present disclosure provide a technical improvement to conventional patch management systems. For instance, in some third-party update networks, updates to a portion of the products 115 are not supported. For instance, patches and software updates provided by vendors of the products 115 may be incompatible with the third-party update network 168. Accordingly, distribution and implementation of the product updates may involve manual package generation or utilization of another manual patch distribution to the endpoints including the products 115 not supported by the third party update network 168. The unsupported products might persist in an unpatched state, may be unnecessarily updated, or there might be significant delays in installation of product updates.

The parser module 116 dynamically derives the compatible update package. Accordingly, the compatible update package may be specific to a corresponding initial SDP and may analyze multiple or all portions of the initial SDP, which may enable processing complicated, multi-path detection and installation instructions of the initial SDP.

Accordingly, embodiments of the present disclosure are directed to a computer-centric problem and are implemented in a computer-centric environment. For instance, the embodiments of the present disclosure are directed to product update management using a combination of a management device 102 of the managed network 110 and the third-party update network 168. Computing processes occurring in the operating environment 100 include communication and implementation of product update packages and modifications thereto, that include software patches and code changes on the products 115 loaded on the endpoints 106. Communications during the processes described in this present disclosure involve the communication of data in electronic and optical forms via a network 120 and also involve the electrical and optical interpretation of the data and information.

The operating environment 100 of FIG. 1 includes the managed network 110, the third-party update network 168, and an unsupported vendor device 113. The managed network 110 includes the management device 102 that communicates with the endpoints 106, the unsupported vendor device 113, and the third-party update network 168 via a network 120. The third-party update network 168 includes a distribution server 112, which communicates data and information related to product updates with the endpoints 106. The components of the operating environment 100 are configured to communicate data and information via the network 120 to perform automated endpoint product management as described in the present disclosure. Each of these components are introduced below.

The network 120 may include any communication network configured for communication of signals between the components (e.g., 102, 113, 108, 112, and 106) of the operating environment 100. The network 120 may be wired or wireless. The network 120 may have configurations including a star configuration, a token ring configuration, or another suitable configuration. Furthermore, the network 120 may include a local area network (LAN), a wide area network (WAN) (e.g., the Internet), and/or other interconnected data paths across which multiple devices may communicate. In some embodiments, the network 120 may include a peer-to-peer network. The network 120 may also be coupled to or include portions of a telecommunications network that may enable communication of data in a variety of different communication protocols.

In some embodiments, the network 120 includes or is configured to include a BLUETOOTH® communication network, a Z-Wave® communication network, a Wi-Fi communication network, a ZigBee communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 120 may include data communicated via short messaging service (SMS), multimedia messaging service (MMS), hypertext transfer protocol (HTTP), direct data connection, wireless application protocol (WAP), or any other protocol that may be implemented in the components of the operating environment 100.

The unsupported vendor device 113 may include a hardware-based computer device configured to communicate data and information with the other components of the operating environment 100 via the network 120. The unsupported vendor device 113 may be associated with a vendor 109 of one of the products 115, which is not supported (unsupported products 123) by the third-party update network 168. The vendor 109 may generate product updates for the unsupported products. In addition, the vendor 109 may generate initial SDPs and update data that may be used to implement and/or install the product update at one or more of the endpoints 106. In some embodiments, the SDPs generated by the vendor 109 may be incompatible with the third-party update network 168. For instance, the distribution server 112 may be unable to process the SDP to effectively detect product update status and/or install the product update.

The unsupported vendor device 113 may generate an update catalog 111. The update catalog 111 includes records and information related to product updates (e.g., currently outstanding and past product updates). As additional product updates for the products 115 become available, update metadata or other information may be appended to the update catalog 111. The unsupported vendor device 113 may communicate the update catalog 111 to the management device 102 or may otherwise make available the update catalog 111. For instance, the unsupported vendor device 113 may post the update catalog 111 to a host site from which the management device 102 is able to access the update catalog 111.

The third-party update network 168 includes the distribution server 112 and the endpoints 106. Additionally, in some embodiments, the third-party update network 168 may include or directly interface with a third-party management module 151 (in Figures, “third-party MGMT module 151”).

The distribution server 112 may be a hardware-based server configured to communicate data and information with the other components of the operating environment 100 via the network 120. The distribution server 112 is configured to at least partially manage product updates at the endpoints 106 within the third-party update network 168. For instance, the distribution server 112 may host, at least temporarily, product updates (e.g., compatible update packages) such that the endpoints 106 can access them or may include links to the product updates. Additionally or alternatively, update packages (e.g., compatible update packages) may be published to the distribution server 112. The update packages include data and information related to product updates such that the product update is locally implemented on the endpoints 106. The update packages may include scripts and/or executables that modify the state of the endpoints 106 to enable installation and implementation of the product updates. Implementation of the product updates at the endpoints 106 include modification to computer code, programming code, or computer-executable instructions of a program that comprise the products 115.

To implement the third-party update network 168 the endpoints 106 may be enrolled. For instance, the endpoints 106 may be enrolled in update management services implemented by the third-party update network 168. After the endpoints 106 are enrolled, ongoing management of the endpoints 106 may be implemented by the distribution server 112. The ongoing management performed by the distribution server 112 may include control of product updates implemented at the endpoints 106 as described in the present disclosure.

The managed network 110 includes the management device 102 and the endpoints 106. The managed network 110 is implemented to enable management of the endpoints 106 by the management device 102. Part of the management of the endpoints 106 may include supplementing the product updates implemented using the third-party update network 168. For instance, the management device 102 may be configured to create and communicate compatible update packages generated by the parser module 116 to the distribution server 112 that would not otherwise be managed by the distribution server 112.

The endpoints 106 may include hardware-based computer systems that are configured to communicate with the other components of the operating environment 100 via the network 120. The endpoints 106 may include any computer device that may be managed by the management device 102 and/or have been enrolled in the managed network 110 and the third-party update network 168. Generally, the endpoints 106 include devices that are operated by the personnel and systems of an enterprise or store data of the enterprise. The endpoints 106 might include workstations of an enterprise, servers, data storage systems, printers, telephones, internet of things (IOT) devices, smart watches, sensors, automobiles, battery charging devices, scanner devices, etc. The endpoints 106 may also include virtual machines, which may include a portion of a single processing unit or one or more portions of multiple processing units, which may be included in multiple machines. The endpoints 106 may be referred to as managed endpoints when the endpoints 106 are included in the managed network 110 and/or the third-party update network 168.

The endpoints 106 include the products 115. The products 115 may include applications of any kind or type. Some examples of the products 115 may include software applications, enterprise software, operating systems, and the like. The first product 115A may not be the same as the second product 115B. For instance, the first products 115A may include a first set of software applications while the second products 115B may include a second set of software applications which may include at least one software application that is not included in the first set of software applications.

The products 115 may include supported products 121 and unsupported products 123. As used in the present disclosure, the unsupported products 123 include a subset of the products 115 with which the third-party update network 168 does not directly interface. Accordingly, there are limitations as to the timing and ability the unsupported products 123 may be patched by the third-party update network 168. For instance, an example of the third-party update network 168 may include Microsoft Intune®. In this example, the unsupported products 123 might include 7-ZIP® products, ADOBE® products, etc. The supported products 121 include products that the third-party update network 168 may be configured to manage. For instance, in the example in which the third-party update network 168 is Microsoft Intune, the supported products 121 might include Microsoft products.

The management device 102 may include a hardware-based computer system that is configured to communicate with the other components of the operating environment 100 via the network 120. The management device 102 may be associated with an administrator 108. The administrator 108 may be an individual, a set of individuals, or a computer system that interfaces with the management device 102. In some embodiments, the administrator 108 may provide input to the management device 102. The input provided by the administrator 108 may form the basis of one or more computing processes performed by the management device 102. For example, the administrator 108 may provide user input at a user interface associated with the management device 102. The user input may indicate that the administrator 108 intends on publishing or distributing a subset of recommended product updates. The user input may take the form of a selection of an icon or button on the management device 102.

The management device 102 may include the parser module 116 and the third-party management module 151. The parser module 116 and the third-party management module 151 may be configured for automated software management of the endpoints 106. For example, the parser module 116 may be configured to convert initial SDPs that include an unsupported product update for implementation on the third-party update network 168.

For example, the parser module 116 may receive the initial SDP. The initial SDP may include one or more rules. The rules may be executed to detect a product update status associated with one or more of the unsupported products 123 at one or both of the endpoints 106 of the managed network 110. The product update status may indicate whether the product update is necessary, whether the product update is applicable, whether the endpoints 106 meet minimum system requirements for the product update, or combinations thereof. Additionally or alternatively, the rules may be executed to install a product update associated with the unsupported product 123 on the endpoint 106. Some examples of an installation rule may include accessing an executable file via an internet link.

The parser module 116 may identify one or more elements of a first rule of the one or more rules of the initial SDP and parse the one or more elements of the first rule. In some embodiments, the parsing may include adding parent components representative of the one or more elements to an expression tree associated with the initial SDP. The parsing may further include detecting one or more functions for the elements. The one or more functions are configured to implement or control implementation of at least a portion of the elements in the third-party update network 168.

The parser module 116 may aggregate the functions for the parsed elements into a script file and convert the expression tree into a final command to perform the script file. The parser module 116 may generate a compatible update package based on the final command. The parser module 116 may communicate the compatible update package to the third-party management module.

The third-party management module may distribute the compatible update package to the distribution server 112 of the third-party update network 168. The compatible update package may be deployed to one or more of the endpoints 106 via the third-party update network 168. The parser module 116 may be implemented to convert one or more SDPs of the update catalog 111 and may be configured to perform conversion operations responsive to changes to the update catalog 111.

Additionally, in some embodiments, the parser module 116 may be configured to generate assessment scripts from update data. The update data may not include the rules of the initial SDP. The parser module 116 may identify characteristics of the update data and identify assessment functions that may enable the distribution server to determine an update status of one or more of the unsupported products 123 associated with the update data.

The parser module 116, the third-party management module 151, the products 115, and components thereof may be implemented using hardware including a processor, a microprocessor (e.g., to perform or control performance of one or more operations), a field-programmable gate array (FPGA), or an application-specific integrated circuit (ASIC). In some other instances, the parser module 116, the third-party management module 151, the products 115, and components thereof may be implemented using a combination of hardware and software. Implementation in software may include rapid activation and deactivation of one or more transistors or transistor elements such as may be included in hardware of a computing system (e.g., the endpoints 106 or the management device 102 of FIG. 1). Additionally, software defined instructions may operate on information within transistor elements. Implementation of software instructions may at least temporarily reconfigure electronic pathways and transform computing hardware.

The managed network 110 may be associated with an enterprise, a portion of an enterprise, a government entity, or another entity or set of devices (102, 113, 106, or 112). In some embodiments, the management device 102, the unsupported vendor device 113, and the distribution server 112 may be a single server, a set of servers, a virtual device, or a virtual server in a cloud-base network of servers. In these and other embodiments, the parser module 116 may be spread over two or more cores, which may be virtualized across multiple physical machines.

Modifications, additions, or omissions may be made to the operating environment 100 without departing from the scope of the present disclosure. For example, the operating environment 100 may include one or more managed networks 110, one or more third-party update networks 168, one or more management devices 102, one or more unsupported vendor device 113, one or more endpoints 106, one or more distribution servers 112, or any combination thereof. Moreover, the separation of various components and devices in the embodiments described herein is not meant to indicate that the separation occurs in all embodiments. Moreover, it may be understood with the benefit of this disclosure that the described components and servers may generally be integrated together in a single component or server or separated into multiple components or servers.

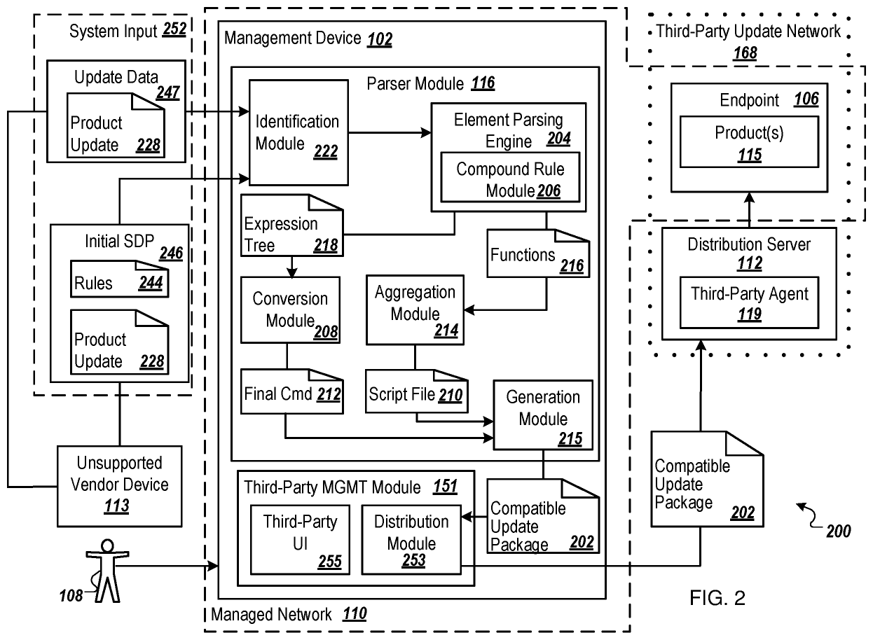

FIG. 2 depicts a block diagram of an example automated software management process (management process) 200 that may be implemented in the operating environment 100 of FIG. 1 or another suitable environment. The management process 200 of FIG. 2 may include one or more components (e.g., 102, 106, 168, 113, 151, and 116) described with reference to FIG. 1. Although not depicted in FIG. 2, communication in the management process 200 may be via a network such as the network 120 of FIG. 1.

The management process 200 includes conversion of an unsupported product update data for deployment via the third-party update network 168. The management process 200 may convert an initial software distribution package (initial SDP) 246 and update data 247. The initial SDP 246 may include metadata and instructions sufficient to deploy a product update for the product 115 on the endpoint 106. However, the product 115 that is updated by the initial SDP 246 may not be supported by the third-party update network 168. Accordingly, the initial SDP 246 may not be formatted correctly to enable the distribution server 112 to directly deploy the product update or to determine an update status of the product 115. The management process 200 may be implemented to convert the initial SDP 246 to a compatible update package 202. The compatible update package 202 is reformatted and converted to include instructions and metadata that enables distribution server 112 of the third-party update network 168 to deploy the product update at the endpoint 106. In some circumstances, the initial SDP 246 may be a part of an update catalog (e.g., the update catalog 111 of FIG. 1) of the unsupported vendor device 113. In these and other circumstances, the management process 200 may be implemented to convert some or all of the update catalog.

Additionally, the management process 200 may be configured to generate an assessment script based on the update data 247. Similar to the initial SDP 246, the update data 247 may relate to one of the products 115 that is not supported by the third-party update network 168. The update data 247 may not include metadata and instructions configured to determine the update status of the product 115 or to implement the product update. The management process 200 may generate the compatible update package 202 that includes an assessment script based on the update data 247. The assessment script is configured to be implemented by the distribution server 112 at the endpoint 106 to determine the update status of the product 115.

The management process 200 of FIG. 2 may begin by the management device 102 receiving the initial SDP 246 or the update data 247 (collectively, system input 252). The system input 252 may be communicated by the unsupported vendor device 113 to the management device 102. Additionally or alternatively, the management device 102 may be configured to access the system input 252. For instance, the system input 252 may be posted on a vendor update server or a public server that is configured to enable the system input 252 to be downloaded.

The initial SDP 246 may include one or more rules 244 and a product update 228. The rules 244 may be executed to detect a product update status associated with one or more of the products 115 at the endpoint 106. Additionally, the rules 244 may be executed to install the product update 228 associated with the product 115 on the endpoint 106.

The update data 247 may not include rules 244 in some embodiments and may include the product update 228. The update data 247 may include data that describes characteristics of the update data 247. For instance, the update data 247 may include an identifier or name of the product updates, dates of availability of a product version, security level of the product updates, urgency of the product updates, threat level of the product updates, vendors of the product updates, applicable programs of the product updates, combinations thereof, or other data describing characteristics of the product updates.

The system input 252 may be further received by the parser module 116. The parser module 116 may include an identification module 222. The identification module 222 is configured to identify one or more elements of the system input 252. In the present disclosure, identified elements may include functional, informational, or operational portions of the rules 244 and the update data 247. For instance, the rules 244 may be composed of one or more elements. Additionally, the update data 247 or the product update 228 may include metadata or other information from which the compatible update package 202 may be generated.

The elements may be communicated to an element parsing engine 204 of the parser module 116. The element parsing engine 204 is configured to parse through multiple or all elements of the initial SDP 246 or the update data 247 and to detect functions 216 for each element or sub-element. The functions 216 include commands or operators that can be implemented by the distribution server 112. The functions 216 may also be configured to implement or control implementation of at least a portion of the element or sub-element in the third-party update network 168. For instance, the functions 216 may be implemented by the distribution server 112 to determine an update status of one or more of the products 115 at the endpoint 106 and to deploy or install the product update 228 at the endpoint 106. In some embodiments, the detecting the functions is based at least partially on a library that dynamically links the elements or the sub-elements to commands of a shell application of the third-party update network 168. In these and other embodiments, the functions 216 may include shell functions that access management functions of an operating system of the third-party update network 168. For instance, the third-party update network 168 may be Microsoft Intune and the functions 216 may include PowerShell Cmdlets.

The rules 244 of the initial SDP 246 may be complex. For instance, the rules 244 may include a detection rule used to determine status of one of the products 115. The detection rule may include evaluation of multiple keys followed by one or more sub-keys that are used by the product 115. Additionally or alternatively, the detection rule may include one or more elements that open every key string value used by the product 115. Additionally or alternatively, the detection rule may include a simple version check of an installed version of one of the products.

Accordingly, the element parsing engine 204 may be configured to evaluate one or more or each of the portions of the elements of the rules 244 and detect one of the functions 216 that correspond to each of the portions. In these and other embodiments, to make the evaluation of the portions of the elements, the element parsing engine 204 may include a compound rule module 206. The compound rule module 206 is configured to parse elements to determine whether the elements include compound rules. For instance, the compound rule module 206 may find compound operators such as an “OR” operator, an “AND” operator, a “NOT” operator, or combinations thereof. The element parsing engine 204 may detect one of the functions 216 for each sub-element or child element stemming from the compound operators.

Additionally, the sub-elements or child elements are further evaluated by the compound rule module 206. For instance, a first element may include a first compound operator (e.g., “OR”). Accordingly, the first element includes a first child element and a second child element. The first child element and the second child element may then be evaluated to determine whether the first child element and the second child element includes an additional compound operator. If the first child element includes one or more of the compound operators, then the first child element may include a first additional child element and a second additional child element. The element parsing engine 204 may detect additional functions 216 for the additional child elements, which are then evaluated as well by the compound rule module 206.

In embodiments in which the parser module 116 is processing the update data 247, the identification module 222 may be configured to identify assessment elements. The assessment elements may be identified from metadata associated with the update data 247 such as version information, product information, etc. The functions 216 detected by the element parsing engine 204 in these embodiments may be related to update status assessment functions. The element parsing engine 204 may be configured to generate an assessment script based on update status assessment functions, which may be a subset of the functions 216. The update status assessment functions may be executed to detect a product update status (e.g., patched or not patched) associated with one of the products 115 at the endpoint 106. The update status assessment element may be parsed or otherwise analyzed to detect the update status assessment functions that may be used to deploy or install the product update 228 of the update data 247. In some embodiments, the assessment functions include shell functions that access management functions of the operating system of the third-party update network 168.

Additionally, in embodiments in which the initial SDP 246 is processed, the element parsing engine 204 may add parent components representative of the elements and child components representative of the sub-elements to an expression tree 218. The expression tree 218 is a binary tree structure in which internal node represent operators (e.g., mathematical operators) and leaf nodes correspond to operands, which are referred to herein as “parent components” or “child components.” The expression tree 218 may be associated with the initial SDP 246. For instance, the expression tree 218 may be uniquely associated with the initial SDP 246. Accordingly, following the parsing of the initial SDP 246 the expression tree 218 may be populated with one or more or each element and sub-element of the initial SDP 246.

The element parsing engine 204 may output the functions 216 to an aggregation module 214. The aggregation module 214 may aggregate the functions 216 into a script file 210. The script file 210 includes the functions 216 formatted as a script file that is executable in the third-party update network 168. In embodiments in which the initial SDP 246 is processed, the script file 210 shares the operational characteristics of the initial SDP 246. For instance, running the script file 210 results in equivalent truth and false values as execution of the initial SDP 246 on the endpoint 106. In embodiments in which the update data 247 is processed, an assessment script may be generated that includes aggregated assessment functions output by the element parsing engine 204.

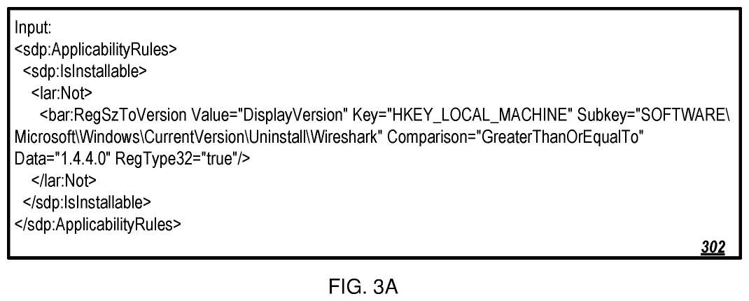

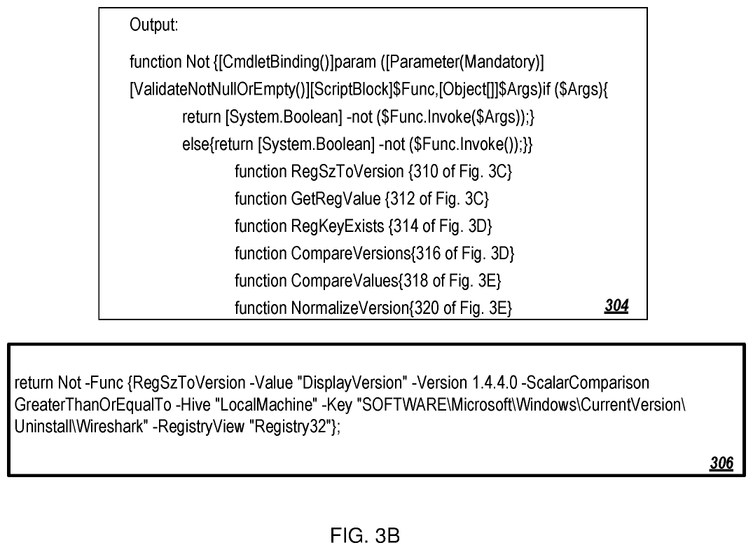

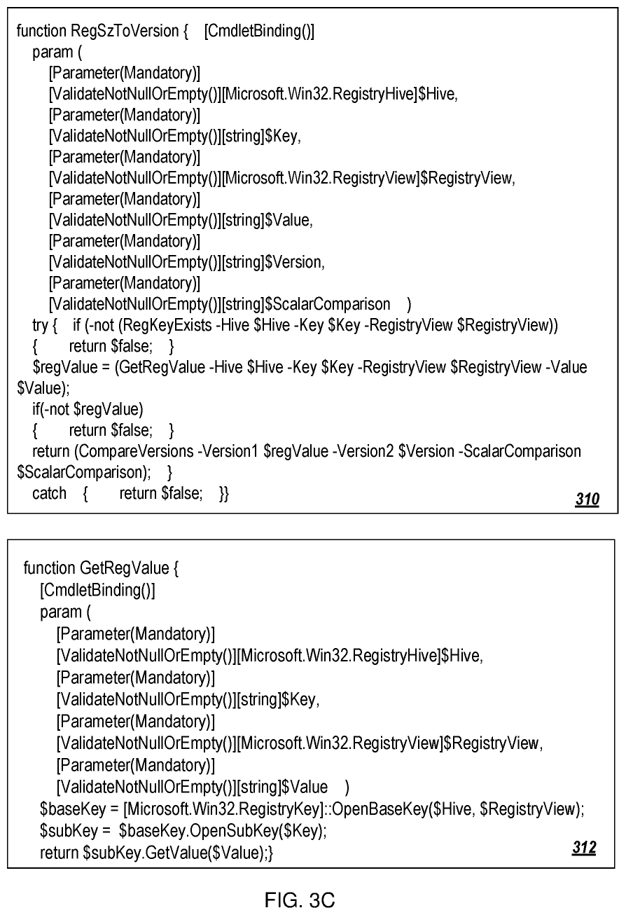

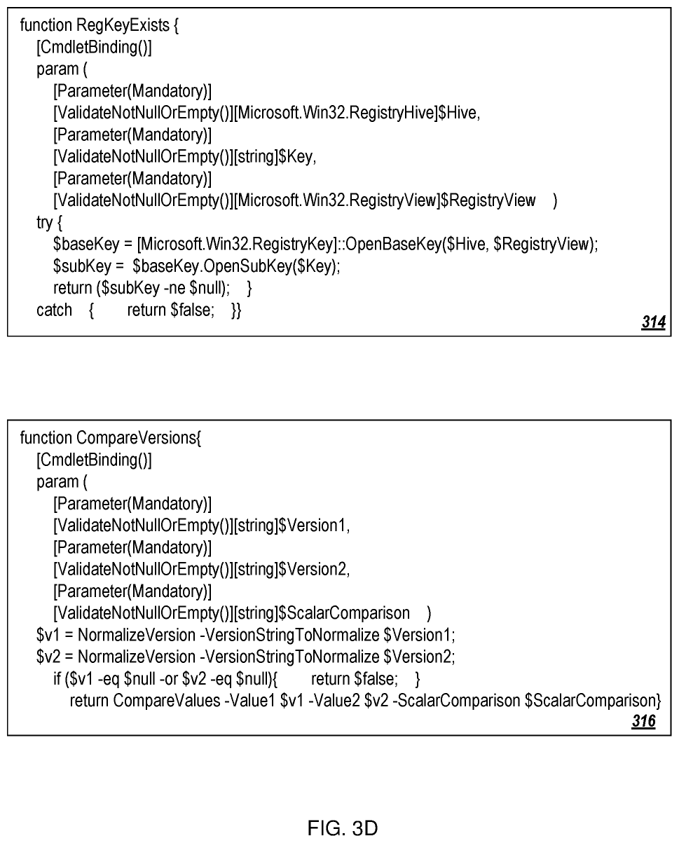

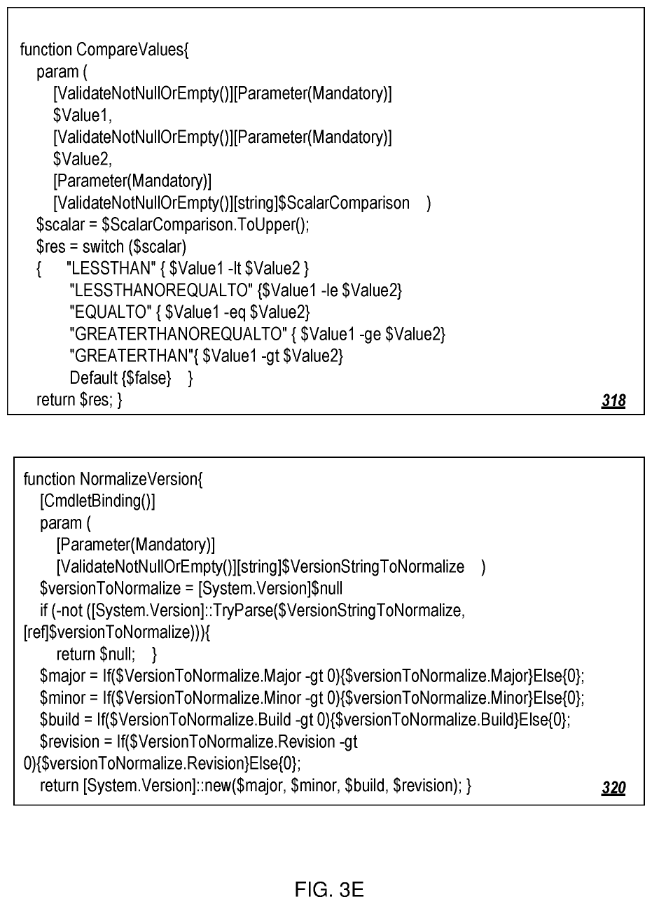

The element parsing engine 204 may output the expression tree 218 to a conversion module 208. The conversion module 208 is configured to convert the expression tree 218 to a final command 212. The final command 212 is configured to implement the script file 210 at the endpoint 106. An example of the final command 212 is shown in FIG. 3B.

The generation module 215 may receive the final command 212 and/or the script file 210. The generation module 215 may generate the compatible update package 202 based on the final command 212 and/or the script file 210. The compatible update package 202 is a derivative of the initial SDP 246 that includes the functions 216 of the script file 210 and the final command 212 that are able to be implemented by the distribution server 112 of the third-party update network 168. In embodiments in which the update data 247 is processed, the compatible update package 202 may include a compatible assessment product update package, which may be based on the assessment script file and/or the update data 247 or portions thereof. For instance, the compatible update package 202 may include an assessment script to obtain information regarding product update status (indicating whether an unpatched state exists at the endpoint 106 relative to the product 115) and an instruction to install the product update 228 at the endpoint 106 responsive to the update status.

The compatible update package 202 is received by the third-party management module 151. Data representative of the receipt of the compatible update package 202 may be displayed to an administrator 108 in some embodiments. For instance, the compatible update package 202 may be displayed in a third-party user interface (UI) 255. Display of the compatible update package 202 may provide some patch management insight, which may be valuable to the administrator 108.

The distribution module 253 may be configured to distribute the compatible update package 202 to the endpoint 106 via the distribution server 112 or otherwise take actions to communicate the compatible update package 202 to the endpoint 106. In some embodiments, the distribution may include communication of the compatible update package 202 indirectly to the endpoint 106. For instance, the compatible update package 202 may be published to the distribution server 112. The endpoint 106 may then access the subset of updates 228 from the distribution server 112.

Distribution of the compatible update package 202 enables local implementation at the endpoint 106. Implementation of the compatible update package 202 may include code changes that are executed or incorporated at the product 115. The distributed compatible update package 202 modifies a portion of a code that makes up the application such that at least one functionality of the application changes following implementation.

In some embodiments, distributing only the compatible update package 202 occurs automatically. For instance, the distribution module 253 may automatically distribute and/or publish the compatible update package 202. The distribution module 253 may automatically distribute and/or publish the compatible update package 202 to the distribution server 112, for instance. The distribution module 253 may automatically distribute and/or publish the compatible update package 202 to a product update status indicating that the product update 228 is outstanding at the endpoint 106.

Additionally or alternatively, the distribution module 253 may be configured to manually publish and distribute the compatible update package 202. For instance, the distribution module 253 may be configured to cause display of the compatible update package 202 in the third-party UI 255. The third-party UI 255 may be configured to receive user input. For instance, the third-party UI 255 may include an icon or electronic button configured to receive the user input and in response the distribution module 253 may distribute the compatible update package 202. As described elsewhere in the present disclosure, distribution (manual and automatic) may include publication to the distribution server 112.

The management process 200 or some operations included therein may be implemented for two or more endpoints 106. The management process 200 may be implemented individually for each endpoint 106 or may be implemented for a group of endpoints 106. The parser module 116 may discover the products 115 of each endpoint 106 or each group of endpoints 106. The product updates applicable to the discovered products may be distributed.

The management process 200 may be repeated. For instance, each time a version is published or the update catalog is updated, the management process 200 may be performed. Additionally, the management process 200 may be performed when the managed network 110 is changed. For instance, the management process 200 may be performed responsive to one or more added endpoints 106, one or more removed endpoints 106, one or more changed products 115, reconfiguring groups of endpoints 106, and the like.

FIGS. 3A-3E provide example input and output from the management process 200. The input and output are based on an embodiment configured to operate with Microsoft Intune and implements PowerShell functions in a script file to implement a product update.

FIG. 3A includes an example input 302. The input 302 may include an Extensible Markup Language (XML) file that includes a detection rule related to installation of a product update. The detection rule is based around a RegSzToVersion operation that includes a “NOT” operator. Accordingly, a product update “IsInstallable” based on values determined, namely the “Version,” “Key,” “Subkey” etc. The input 302 is an example of a portion of an initial SDP 246 of FIG. 2. The input 302 is not configured to operate in the Intune network as is. Accordingly, the management process 200 may be applied to the input 302 to derive outputs of FIGS. 3B-3E.

FIG. 3B includes an example script file 304 and an example final command 306. The script file 304 may be an example of the script file 210 of FIG. 2 and the final command 306 may be an example of the final command 212 of FIG. 2. The script file 304 includes an aggregation of functions detected for the rules in the input 302 of FIG. 3A. The script file 304 is organized according to the “NOT” operator of the input 302 and includes seven functions, one for each of the values and operations of the RegSzToVersion operation of the input 302. Each of the function are shown in the following FIGS. 3C-3E and include a PowerShell command that operates in the operating system of Microsoft Intune. Similarly, the final command 306 of FIG. 3B depicts computer instructions that may be implemented by the Intune system to return values obtained by execution of the script file 304.

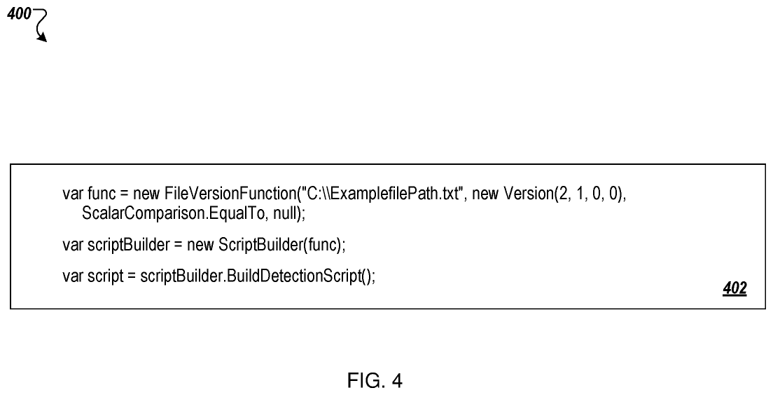

FIG. 4 depicts an application programming interface (API) 400 that may be implemented to generate assessment scripts using the management process 200. The API 400 may be used to process the update data 247 to create a compatible update package including an assessment script. The API 400 may be put behind a user interface such as the third-party UI 255 or used to parse one or more different schema (other than XML schema of some initial SDPs) of detection logic into assessment scripts.

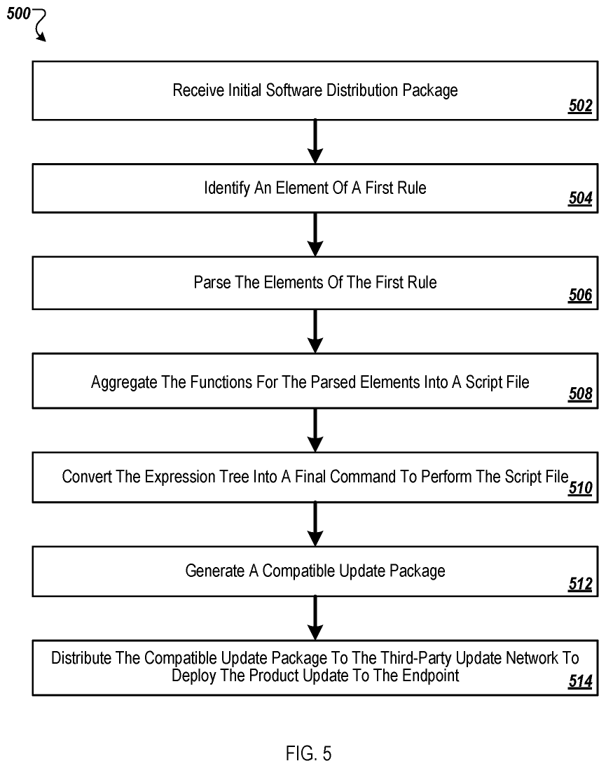

FIG. 5 is a flow chart of an example method 500 of conversion of an unsupported product update package for implementation on a third-party update network, according to at least one embodiment of the present disclosure. The method 500 may begin at block 502 in which an initial SDP may be received. The initial SDP may include one or more rules executed to detect a product update status associated with a product at an endpoint of a managed network and to install a product update associated with the product on the endpoint. In some embodiments, the product is not supported by a third-party update network implemented to manage product updates on the endpoint. In some embodiments the initial SDP includes an extensible markup language (XML) file. The XML file may be included as update catalog entry for the product in an update catalog that aggregates multiple product update packages. At block 504, one or more elements of a first rule may be identified. For instance, one or more elements of a first rule of the one or more rules of the initial SDP may be identified. At block 506, the one or more elements of the first rule may be parsed. At block 508, the function for the parsed element may be aggregated into a script file. In some embodiments, the aggregating the functions for the parsed elements into the script file includes aggregating the additional functions of two or more child elements into the script file. For instance, the aggregation of the additional functions may be performed in circumstances in which the elements of the first rule include one or more compound rules. At block 510, the expression tree may be converted. The expression tree may be converted into a final command to perform the script file. In some embodiments, converting the expression tree may include conversion of child elements in circumstances in which the elements of the first rule include one or more compound rules.

At block 512, a compatible update package may be generated. The compatible update package may be based on the final command. At block 514, the compatible update package may be distributed. The compatible update package may be distributed to the third-party update network to deploy the product update to the endpoint.

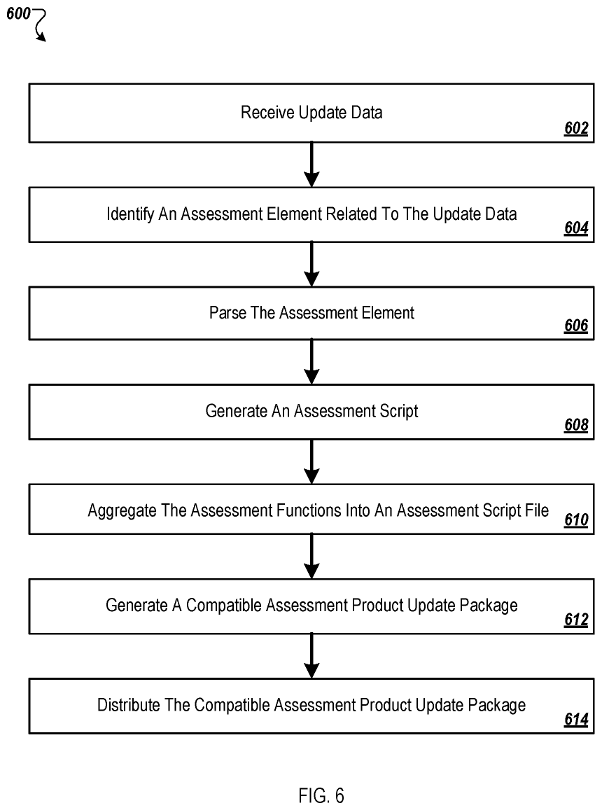

FIG. 6 is a flow chart of an example method 600 of conversion of unsupported update data for implementation on a third-party update network, according to at least one embodiment of the present disclosure. The method 600 may begin at block 602 in which an update data may be received. The update data may be related to a second product update for a second product. The update data may not include a detection rule executed to detect a second product update status associated with the second product at an endpoint. In some embodiments, the second product is not supported by a third-party update network. Additionally, in some embodiments, the update data related to a second product update may be formatted according to a non-XML programming language.

At block 604, an assessment element related to the update data may be identified. The assessment element may be configured to implement or control implementation of an operation to detect the second product update status at the endpoint by the third-party update network. At block 606, the assessment element may be parsed. The assessment element may be parsed to identify assessment functions that correlate the assessment functions to the assessment element. In some embodiments, the assessment functions include shell functions that access management functions of an operating system of the third-party update network. At block 608, an assessment script may be generated for the second product update. The assessment script may include the assessment functions.

At block 610, the assessment functions may be aggregated. For instance, the assessment functions may be aggregated into an assessment script file. At block 612, a compatible assessment product update package may be generated. The compatible assessment product update package may be generated based on the assessment script file.

At block 614, the compatible assessment product update package may be distributed to the third-party update network for deployment to the endpoint. In some embodiments, the compatible assessment product update package further includes an instruction to install the second product update at the endpoint responsive to the second product update status indicating an unpatched state exists at the endpoint relative to the second product.

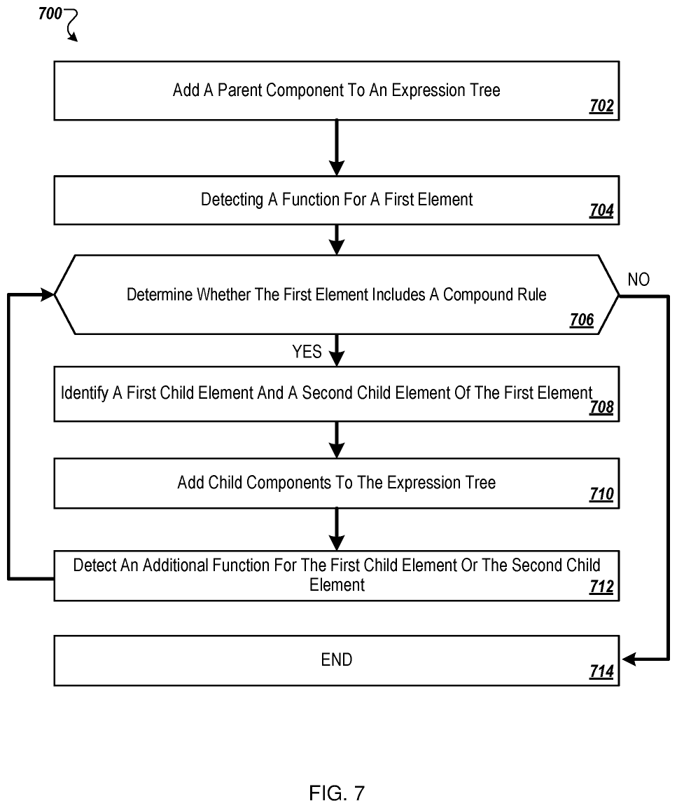

FIG. 7 is a flow chart of an example method 700 of parsing an element, according to at least one embodiment of the present disclosure. In some embodiments, the method 700 may be implemented as a portion of another method. For instance, the method 700 may be implemented in block 506 of the method 500 of FIG. 5 or block 606 of the method 600 of FIG. 6. The method 700 may begin at block 702 in which a parent component may be added to an expression tree. The parent element added to the expression tree may correspond or be representative of the element being parsed. The expression tree may be associated with the initial SDP. At block 704 a function for the first element may be detected. The function may be configured to implement or control implementation of at least a portion of the first element in a third-party update network. In some embodiments, the detecting the function for the first element is based at least partially on a library that dynamically links the first element to commands of a shell application of the third-party update network. Additionally, in some embodiments, the one or more functions include shell functions that access management functions of an operating system of the third-party update network. For instance, in these and other embodiments, the function may include a PowerShell® cmdlet and the third-party update network may include Microsoft Intune®.

At block 706, it may be determined whether the first element includes a compound rule. The compound rule may include an “AND” operator, an “OR” operator, an “NOT” operator, or combinations thereof. In circumstances in which the first element includes the compound rule, the first element may be separated into a first child element (e.g., a true statement or path) and a second child element (e.g., a false statement or path). Responsive to the first element not including the compound rule (“NO” at block 706), the method 700 may proceed to block 714 where the method 700 ends. Accordingly, if the first element does not include the compound rule, a parent component representative of the element would be added to the expression tree and the function for the first element may be detected.

Responsive to the first element including the compound rule (“YES” at block 706), the method 700 may proceed to block 708. At block 708, the first child element and the second child element of the first element may be identified. Again, the first child element may include a “true” statement or path and the second child element may include a “false” statement or path. At block 710, child components representative of the first child element and the second child element may be added to the expression tree. At block 712, an additional function may be detected for the first child element and/or the second child element. Accordingly, following block 712, the first child element and the second child element may be added to the expression tree and the additional functions may be detected.

The method 700 may proceed from block 712 to block 706. At block 706 it may be determined whether the first child element and/or the second child element includes a second (or third) compound rule. For instance, the first child element may be a “true” path of the first element. The first child element may include another compound rule (e.g., another operation including an AND, OR, or NOT operator). Responsive to the first child element or the second child element including another child rule (“YES” at block 706), the method 700 may proceed from block 706 through blocks 708, 710, and 712 applied to additional child elements. This loop from blocks 706, 708, 710, and 712 may proceed until components (parent or child) representative of the first element and each path for each compound rule is added to the expression tree and a function is correlated to each element or sub-element.

As an example, at block 706 it may be determined whether the first child element and the second child element include an additional compound rule. Responsive to the first child element including the additional compound rule (“YES” at block 706), a first additional child element and a second additional child element of the first child element may be identified (in block 708). Additional child components representative of the first additional child element and the second additional child element may be added to the expression tree and an additional function for the first additional child element and the additional second child element may be detected.

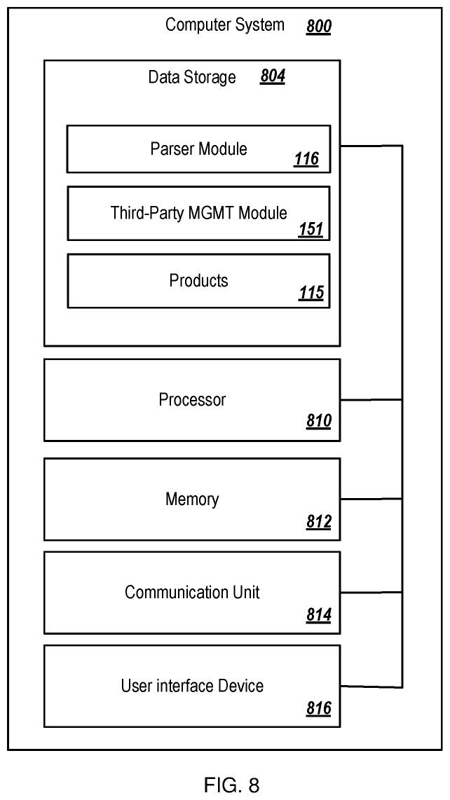

The methods 500, 600, and 700 may be performed in a suitable operating environment such as the operating environment 100 of FIG. 1. The methods 500, 600, and 700 may be performed by the management device 102 described elsewhere in the present disclosure or by another suitable computing system, such as the computer system 800 of FIG. 8. In some embodiments, the management device 102 or the other computing system may include or may be communicatively coupled to a non-transitory computer-readable medium (e.g., the memory 812 of FIG. 8) having stored thereon programming code or instructions that are executable by one or more processors (such as the processor 810 of FIG. 8) to cause a computing system or the management device 102 to perform or control performance of the methods 500, 600, and 700. Additionally or alternatively, the management device 102 may include the processor 810 that is configured to execute computer instructions to cause the management device 102 or another computing systems to perform or control performance of the 500, 600, and 700. The management device 102 or the computer system 800 implementing the 500, 600, and 700 may be included in a cloud-based managed network, an on-premises system, or another suitable network computing environment. Although illustrated as discrete blocks, one or more blocks in FIGS. 5, 6, and 7 may be divided into additional blocks, combined into fewer blocks, or eliminated, depending on the desired implementation.

Further, modifications, additions, or omissions may be made to the 500, 600, and 700 without departing from the scope of the present disclosure. For example, the operations of 500, 600, and 700 may be implemented in differing order. Furthermore, the outlined operations and actions are only provided as examples, and some of the operations and actions may be optional, combined into fewer operations and actions, or expanded into additional operations and actions without detracting from the disclosed embodiments.

FIG. 8 illustrates an example computer system 800 configured for conversion of an unsupported product update data for deployment via a third-party update network, according to at least one embodiment of the present disclosure. The computer system 800 may be implemented in the operating environment 100 of FIG. 1, for instance. Examples of the computer system 800 may include the management device 102, the endpoints 106, the distribution server 112, the unsupported vendor device 113, or some combination thereof. The computer system 800 may include one or more processors 810, a memory 812, a communication unit 814, a user interface device 816, and a data storage 804 that includes the update parser module 116, the third-party management module 151, and the products 115 (collectively modules) configured for conversion of an unsupported product update data for deployment via a third-party update network.

The processor 810 may include any suitable special-purpose or general-purpose computer, computing entity, or processing device including various computer hardware or software modules and may be configured to execute instructions stored on any applicable computer-readable storage media. For example, the processor 810 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 8, the processor 810 may more generally include any number of processors configured to perform individually or collectively any number of operations described in the present disclosure. Additionally, one or more of the processors 810 may be present on one or more different electronic devices or computing systems. In some embodiments, the processor 810 may interpret and/or execute program instructions and/or process data stored in the memory 812, the data storage 804, or the memory 812 and the data storage 804. In some embodiments, the processor 810 may fetch program instructions from the data storage 804 and load the program instructions in the memory 812. After the program instructions are loaded into the memory 812, the processor 810 may execute the program instructions.

The memory 812 and the data storage 804 may include computer-readable storage media for carrying or having computer-executable instructions or data structures stored thereon. Such computer-readable storage media may include any available media that may be accessed by a general-purpose or special-purpose computer, such as the processor 810. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 810 to perform a certain operation or group of operations.

The communication unit 814 may include one or more pieces of hardware configured to receive and send communications. In some embodiments, the communication unit 814 may include one or more of an antenna, a wired port, and modulation/demodulation hardware, among other communication hardware devices. In particular, the communication unit 814 may be configured to receive a communication from outside the computer system 800 and to present the communication to the processor 810 or to send a communication from the processor 810 to another device or network (e.g., 120 of FIG. 1).

The user interface device 816 may include one or more pieces of hardware configured to receive input from and/or provide output to a user. In some embodiments, the user interface device 816 may include one or more of a speaker, a microphone, a display, a keyboard, a touch screen, or a holographic projection, among other hardware devices.

The modules may include program instructions stored in the data storage 804. The processor 810 may be configured to load the assessment engine 105 into the memory 812 and execute the modules. Alternatively, the processor 810 may execute the assessment engine 105 line-by-line from the data storage 804 without loading them into the memory 812. When executing the assessment engine 105, the processor 810 may be configured to perform one or more processes or operations described elsewhere in this disclosure.

Modifications, additions, or omissions may be made to the computer system 800 without departing from the scope of the present disclosure. For example, in some embodiments, the computer system 800 may not include the user interface device 816. In some embodiments, the different components of the computer system 800 may be physically separate and may be communicatively coupled via any suitable mechanism. For example, the data storage 804 may be part of a storage device that is separate from a device, which includes the processor 810, the memory 812, and the communication unit 814, that is communicatively coupled to the storage device. The embodiments described herein may include the use of a special-purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data which cause a general-purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

All examples and conditional language recited herein are intended for pedagogical objects to aid the reader in understanding the embodiments and the concepts contributed to furthering the art and are to be construed as being without limitation to such specifically recited examples and conditions. Although embodiments have been described in detail, various changes, substitutions, and alterations could be made hereto without departing from the scope of the embodiments.

What is claimed:

1. A method of conversion of unsupported product update data for deployment via a third-party update network, the method comprising:
receiving an initial software distribution package including one or more rules executed to detect a product update status associated with a product at an endpoint of a managed network and to install a product update associated with the product on the endpoint, wherein the product is not supported by a third-party update network implemented to managed product updates on the endpoint;
identifying one or more elements of a first rule of the one or more rules of the initial software distribution package;
parsing the one or more elements of the first rule, the parsing including:
adding parent components representative of the one or more elements to an expression tree associated with the initial software distribution package; and
detecting one or more functions for the one or more elements, wherein the one or more functions are configured to implement or control implementation of at least a portion of at least one element of the one or more elements in the third-party update network;
aggregating the functions for the parsed elements into a script file;
converting the expression tree into a final command to perform the script file;
generating a compatible update package based on the final command; and
distributing the compatible update package to the third-party update network to deploy the product update to the endpoint.

2. The method of claim 1, wherein the parsing further includes:
determining whether a first element of the one or more elements includes a compound rule;
responsive to the first element including the compound rule:
identifying a first child element and a second child element of the first element;
adding child components representative of the first child element and the second child element to the expression tree; and
detecting one or more additional functions for the first child element and the second child element.

3. The method of claim 2, wherein:
the aggregating the functions for the parsed elements into the script file includes aggregating the additional functions into the script file; and
the converting the expression tree includes conversion of the first child element and the second child element.

4. The method of claim 2, wherein the parsing further includes:
determining whether the first child element and the second child element include an additional compound rule;
responsive to the first child element including the additional compound rule:
identifying a first additional child element and a second additional child element of the first child element;
adding additional child components representative of the first additional child element and the second additional child element to the expression tree; and
detecting one or more additional functions for the first additional child element and the additional second child element.

5. The method of claim 2, wherein:
the compound rule includes:
an “AND” operator,
an “OR” operator, or
an “NOT” operator;
the initial software distribution package includes an extensible markup language (XML) file; and
the XML file is included as update catalog entry for the product in an update catalog that aggregates a plurality of product update packages.

6. The method of claim 1, wherein:
the one or more functions include shell functions that access management functions of an operating system of the third-party update network;
the one or more functions include a PowerShell® cmdlet; and
the third-party update network includes Microsoft Intune®.

7. The method of claim 1, wherein the detecting the one or more functions is based on at least partially on a library that dynamically links the one or more elements to commands of a shell application of the third-party update network.

8. The method of claim 1, further comprising:
receiving update data related to a second product update for a second product, the update data not including a detection rule executed to detect a second product update status associated with the second product at the endpoint, wherein the second product is not supported by the third-party update network;
identifying an assessment element related to the update data, the assessment element being configured to implement or control implementation of an operation to detect the second product update status at the endpoint by the third-party update network;
parsing the assessment element to identify assessment functions that correlate to the assessment element;
generating an assessment script for the second product update, the assessment script including the assessment functions;
aggregating the assessment functions into an assessment script file;
generating a compatible assessment product update package based on the assessment script file; and
distributing the compatible assessment product update package to the third-party update network for deployment to the endpoint.

9. The method of claim 8, wherein:
update data related to a second product update is formatted according to a non-XML programming language; and
the assessment functions include shell functions that access management functions of an operating system of the third-party update network.

10. The method of claim 9, wherein the compatible assessment product update package further includes an instruction to install the second product update at the endpoint responsive to the second product update status indicating an unpatched state exists at the endpoint relative to the second product.

11. A non-transitory computer-readable medium having encoded therein programming code executable by one or more processors to perform or control performance of operations to convert unsupported product update data for deployment via a third-party update network, the operations comprising:
receiving an initial software distribution package including one or more rules executed to detect a product update status associated with a product at an endpoint of a managed network and to install a product update associated with the product on the endpoint, wherein the product is not supported by a third-party update network implemented to managed product updates on the endpoint;
identifying one or more elements of a first rule of the one or more rules of the initial software distribution package;
parsing the one or more elements of the first rule, the parsing including:
adding parent components representative of the one or more elements to an expression tree associated with the initial software distribution package; and
detecting one or more functions for the one or more elements, wherein the one or more functions are configured to implement or control implementation of at least a portion of at least one element of the one or more elements in the third-party update network;
aggregating the functions for the parsed elements into a script file;
converting the expression tree into a final command to perform the script file;
generating a compatible update package based on the final command; and
distributing the compatible update package to the third-party update network to deploy the product update to the endpoint.

12. The non-transitory computer-readable medium of claim 11, wherein the parsing further includes:
determining whether a first element of the one or more elements includes a compound rule;
responsive to the first element including the compound rule:
identifying a first child element and a second child element of the first element;
adding child components representative of the first child element and the second child element to the expression tree; and
detecting one or more additional functions for the first child element and the second child element.

13. The non-transitory computer-readable medium of claim 12, wherein:
the aggregating the functions for the parsed elements into the script file includes aggregating the additional functions into the script file; and
the converting the expression tree includes conversion of the first child element and the second child element.

14. The non-transitory computer-readable medium of claim 12, wherein the parsing further includes:
determining whether the first child element and the second child element include an additional compound rule;
responsive to the first child element including the additional compound rule:
identifying a first additional child element and a second additional child element of the first child element;
adding additional child components representative of the first additional child element and the second additional child element to the expression tree; and
detecting one or more additional functions for the first additional child element and the additional second child element.

15. The non-transitory computer-readable medium of claim 12, wherein:
the compound rule includes:
an “AND” operator,
an “OR” operator, or
an “NOT” operator;
the initial software distribution package includes an extensible markup language (XML) file; and
the XML file is included as update catalog entry for the product in an update catalog that aggregates a plurality of product update packages.

16. The non-transitory computer-readable medium of claim 11, wherein:
the one or more functions include shell functions that access management functions of an operating system of the third-party update network;
the one or more functions include a PowerShell® cmdlet; and
the third-party update network includes Microsoft Intune®.

17. The non-transitory computer-readable medium of claim 11, wherein the detecting the one or more functions is based on at least partially on a library that dynamically links the one or more elements to commands of a shell application of the third-party update network.

18. The non-transitory computer-readable medium of claim 11, wherein the operations further comprise:
receiving update data related to a second product update for a second product, the update data not including a detection rule executed to detect a second product update status associated with the second product at the endpoint, wherein the second product is not supported by the third-party update network;
identifying an assessment element related to the update data, the assessment element being configured to implement or control implementation of an operation to detect the second product update status at the endpoint by the third-party update network;
parsing the assessment element to identify assessment functions that correlate to the assessment element;
generating an assessment script for the second product update, the assessment script including the assessment functions;
aggregating the assessment functions into an assessment script file;
generating a compatible assessment product update package based on the assessment script file; and
distributing the compatible assessment product update package to the third-party update network for deployment to the endpoint.

19. The non-transitory computer-readable medium of claim 18, wherein:
update data related to a second product update is formatted according to a non-XML programming language; and
the assessment functions include shell functions that access management functions of an operating system of the third-party update network.

20. The non-transitory computer-readable medium of claim 19, wherein the compatible assessment product update package further includes an instruction to install the second product update at the endpoint responsive to the second product update status indicating an unpatched state exists at the endpoint relative to the second product.
